(19) United States
(12) Patent Application Publication
(10) Pub. No.: US 2009/0012229 A1
(43) Pub. Date: Jan. 8, 2009

(54) PARTIALLY AROMATIC COPOLYAMIDES WITH A HIGH CRYSTALLINITY

(75) Inventors: Philippe Desbois, Edingen-Neckarhausen (DE); Gerd Blinne, Bobenheim (DE); Ralf Neuhaus, Heidelberg (DE); Hagen Stawitzki, Karlsruhe (DE); Hans-Joachim Weis, Ludwigshafen (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 12/282,059

(22) PCT Filed: Feb. 28, 2007
(86) PCT No.: PCT/EP2007/051865

§ 371 Date: Sep. 8, 2008

(30) Foreign Application Priority Data
Mar. 8, 2006 (EP) 06110815.5

(51) Int. Cl. C08L 77/06; C08G 69/26

(52) U.S. Cl. 524/538; 528/338

(57) ABSTRACT

Semiaromatic semicrystalline thermoplastic polyamide molding compositions, comprising
A) from 40 to 100% by weight of a copolyamide composed of
   a1) from 30 to 44 mol % of units which derive from terephthalic acid
   a2) from 6 to 20 mol % of units which derive from isophthalic acid
   a3) from 42 to 49.5 mol % of units which derive from hexamethylenediamine
   a4) from 0.5 to 8 mol % of units which derive from aromatic diamines having from 6 to 30 carbon atoms,
      where the molar percentages of components a1) to a4) together give 100%, and
B) from 0 to 50% by weight of a fibrous or particulate filler
C) from 0 to 30% by weight of an elastomeric polymer
D) from 0 to 30% by weight of other additives and processing aids,
   where the percentages by weight of components A) to D) together give 100%.

The invention relates to semiaromatic semicrystalline thermoplastic polyamide molding compositions, comprising

A) from 40 to 100% by weight of a copolyamide composed of
a1) from 30 to 44 mol % of units which derive from terephthalic acid
a2) from 6 to 20 mol % of units which derive from isophthalic acid
a3) from 42 to 49.5 mol % of units which derive from hexamethylenediamine
a4) from 0.5 to 8 mol % of units which derive from aromatic diamines having from 6 to 30 carbon atoms,
   where the molar percentages of components a1) to a4) together give 100%, and
   B) from 0 to 50% by weight of a fibrous or particulate filler
   C) from 0 to 30% by weight of an elastomeric polymer
   D) from 0 to 30% by weight of other additives and processing aids,
   where the percentages by weight of components A) to D) together give 100%.

The invention moreover relates to the use of these molding compositions for production of fibers, of foils, or of moldings, and also to the moldings obtainable from the inventive molding compositions.

Transparent, amorphous polyamides composed of terephthalic acid/isophthalic acid (IPS/TPS) and hexamethylenediamine (HMD), and also m- or p-xylylenediamine (MXD/PXD) are known from U.S. Pat. No. 5,028,462 and GB-766 927.

JP-A 08/3312 discloses very high proportions of TPS, with very difficult processing.

According to the technical teaching of the specifications, the known amorphous copolyamides are transparent and exhibit only very small crystalline fractions.

Although this is advantageous for applications where resistance to chemicals or transparency of the moldings is a requirement, amorphous polyamides exhibit disadvantages in applications such as the engine compartment sector which require durability at high ambient temperature. Semiaromatic copolyamides composed of terephthalic/isophthalic acid units with various other structural components are known inter alia from EP-A 121 984, EP-A 291 096, U.S. Pat. No. 4,607,073, EP-A 217 960, and EP-A 299 444.

Although high proportions of hexamethylenediamine/terephthalic acid improve crystallinity and significantly increase glass transition temperatures, increasing content of these units does however impair processibility (temperatures mostly above 320° C., or 350° C. for filled polyamides) and preparation of polyamides of this type (see R. D. Chapman et al., Textile Research Journal 1981, p. 564).

It was an object of the present invention to provide semicrystalline semiaromatic copolyamide molding compositions which have a high degree of crystallinity and high glass transition temperature with sufficiently high melting points to give better processibility for the copolyamides. At the same time, the intention is that the copolyamides exhibit better mechanical properties (in particular multiaxial impact resistance) and surface quality of fiber-reinforced moldings.

Accordingly, the molding compositions defined at the outset have been found.

Preferred embodiments are given in the subclaims.

The inventive semiaromatic semicrystalline thermoplastic polyamide molding compositions comprise, as component A), from 40 to 100% by weight, preferably from 50 to 100% by weight, and in particular from 70 to 100% by weight, of a copolyamide, composed of

a1) from 30 to 44 mol %, preferably from 32 to 40 mol %, and in particular from 32 to 38 mol %, of units which derive from terephthalic acid,
a2) from 6 to 20 mol %, preferably from 10 to 18 mol % and in particular from 12 to 18 mol %, of units which derive from isophthalic acid,
a3) from 42 to 49.5 mol %, preferably from 45 to 48.5 mol %, and in particular from 46.5 to 48 mol % of units which derive from hexamethylenediamine,
a4) from 0.5 to 8 mol %, preferably from 1.5 to 5 mol %, and in particular from 2 to 3.5 mol %, of units which derive from aromatic diamines having from 6 to 30, preferably from 6 to 29, and in particular from 6 to 17, carbon atoms,
where the molar percentages of components a1) to a4) together give 100%.

The diamine units a3) and a4) are preferably reacted equimolecularly with the dicarboxylic acid units a1) and a2).

Suitable monomers a4) are preferably cyclic diamines of the formula

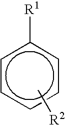

in which

### R¹ is NH₂ or NHR³,

R² is in m-, o- or p-position with respect to R¹, and is NH₂ or NHR³,
where R³ is an alkyl radical having from 1 to 6 carbon atoms, preferably from 1 to 4 carbon atoms.

Particularly preferred diamines are p- and/or m-xylylenediamine or a mixture of these.

Other monomers a4) that may be mentioned are o-xylylenediamine and alkyl-substituted xylylenediamines.

The semiaromatic copolyamides A) can comprise, alongside the units a1) to a4) described above, up to 4% by weight, preferably up to 3.5% by weight, based on A), of other polyamide-forming monomers a5), these being those known from other polyamides.

Aromatic dicarboxylic acids a5) have from 8 to 16 carbon atoms. Examples of suitable aromatic dicarboxylic acids are substituted terephthalic and isophthalic acids, such as 3-tert-butylisophthalic acid, polynuclear dicarboxylic acids, e.g. 4,4′- and 3,3′-diphenyldicarboxylic acid, 4,4′- and 3,3′-diphenylmethanedicarboxylic acid, 4,4′- and 3,3′-diphenyl sulfone dicarboxylic acid, 1,4- or 2,6-naphtalenedicarboxylic acid, and phenoxyterephthalic acid.

Other polyamide-forming monomers a5) can derive from dicarboxylic acids having from 4 to 16 carbon atoms and from aliphatic diamines having from 4 to 16 carbon atoms, or else from aminocarboxylic acids or, respectively, corresponding lactams having from 7 to 12 carbon atoms. Just a few suitable monomers of these types may be mentioned here: suberic acid, azelaic acid, or sebacic acid as representatives of the aliphatic dicarboxylic acids, 1,4-butanediamine, 1,5-pentanediamine, or piperazine as representatives of the diamines, and caprolactam, caprylolactam, enantholactam, aminoundecanoic acid, and laurolactam as representatives of lactams or aminocarboxylic acids.

Other semiaromatic copolyamides which have proven particularly advantageous are those whose triamine content is less than 0.5% by weight, preferably less than 0.3% by weight.

The triamine contents of semiaromatic copolyamides prepared by most of the known processes (cf. U.S. Pat. No. 4,603,166) are above 0.5% by weight, and this leads to impairment of product quality and to problems in continuous preparation processes. A triamine which may be mentioned and is a particular cause of these problems is dihexamethylenetriamine, which forms from the hexamethylenediamine used in the preparation process.

Copolyamides with low triamine content have lower melt viscosities when compared with products of identical constitution having higher triamine content, but have the same solution viscosity. The result is a considerable improvement not only in processibility but also in product properties.

The melting points of the semiaromatic copolyamides are from 290° C. to 340° C., preferably from 292 to 330° C., and this melting point is usually associated with a high glass transition temperature of generally above 120° C., in particular above 130° C. (in the dry state).

According to the invention, semiaromatic copolyamides generally feature degrees of crystallinity of >30%, preferably >35%, and in particular >40%.

The degree of crystallinity is a measure of the proportion of crystalline fragments in the copolyamide, and is determined by X-ray diffraction, or indirectly by measuring ΔH_{crist}.

It is, of course, also possible to use mixtures of the semiaromatic copolyamides in any desired ratio.

Suitable processes for preparing the inventive copolyamides are known to the skilled worker.

A preferred method of preparation is the batch process. For this, the aqueous monomer solution is heated in an autoclave to between 280 and 340° C. for from 0.5 to 3 h, during which the pressure reached is from 10 to 50 bar, in particular from 15 to 40 bar, and this pressure is held as steady as possible for up to 2 h by releasing excess water vapor. The pressure in the autoclave is then released at constant temperature within a period of from 0.5 to 2 h until a final pressure of from 1 to 5 bar has been reached. The polymer melt is then discharged, cooled and pelletized.

Another process is based on the processes described in EP-A 129195 and 129 196.

According to that process, an aqueous solution of the monomers a1) to a4), and also, if appropriate, a5) with monomer content of from 30 to 70% by weight, preferably from 40 to 65% by weight, is heated under elevated pressure (from 1 to 10 bar) with simultaneous evaporation of water and formation of a prepolymer within less than 60 s to a temperature of from 280 to 330° C., and then prepolymers and vapor are continuously separated, the vapor is rectified and the entrained diamines are returned. Finally, the prepolymer is passed into a polycondensation zone and polycondensed at a gauge pressure of from 1 to 10 bar at from 280 to 330° C. with a residence time of from 5 to 30 min. The temperature in the reactor is, of course, above that required at the respective water-vapor pressure to melt the prepolymer being produced.

These short residence times substantially prevent the formation of triamines.

The polyamide prepolymer obtained in the manner described and generally having a viscosity number of from 40 to 70 ml/g, preferably from 40 to 60 ml/g, measured from a 0.5% strength by weight solution in 96% strength sulfuric acid at 25° C., is continuously removed from the condensation zone.

According to one preferred method of operation, the resultant polyamide prepolymer is discharged as melt through a discharge zone, and at the same time the residual water present in the melt is removed. An example of a suitable discharge zone is a vented extruder. The melt freed from water may then be cast into extrudates and pelletized.

In one particularly preferred embodiment it is also possible for components B) and, if appropriate, C) and/or D) to be added to the prepolymer of component A) before the material leaves the vented extruder. In this case the vented extruder usually has suitable mixing elements, such as kneading blocks. Here again, this may be followed by extruding, cooling and pelletizing.

These pellets are condensed in the solid phase under an inert gas, continuously or batchwise, at below their melting point, e.g. at from 170 to 240° C., to the desired viscosity. For the batchwise solid-phase condensation use may be made, for example, of tumbling dryers. For the continuous solid-phase condensation, conditioning tubes through which hot inert gas flows may be used. Preference is given to continuous solid-phase condensation in which the inert gas used comprises nitrogen or, in particular, superheated steam, advantageously the steam produced at the head of the column.

The viscosity number after the postcondensation in the solid phase or after the other preparation processes mentioned above is generally from 100 to 500 ml/g, preferably from 110 to 200 ml/g, measured from a 0.5% strength by weight solution in 96% strength sulfuric acid at 25° C.

The inventive copolyamides can comprise, as further constituent, from 0 to 50% by weight, preferably up to 35% by weight, in particular from 15 to 35% by weight, of a fibrous or particulate filler (component (B)), or a mixture of these.

Preferred fibrous reinforcing materials are carbon fibers, potassium titanate whiskers, aramid fibers, and particularly preferably glass fibers. If glass fibers are used, these may have been equipped with a coupling agent and with a size to improve compatibility with the thermoplastic polyamide (A). The diameter of the glass fibers used is generally in the range from 6 to 20 μm.

The glass fibers incorporated can either take the form of short glass fibers or else take the form of continuous-filament strands (rovings). The average length of the glass fibers in the finished injection molding is preferably in the range from 0.08 to 0.5 mm.

Suitable particulate fillers are amorphous silica, magnesium carbonate (chalk), kaolin (in particular calcined kaolin), powdered quartz, mica, talc, feldspar, and in particular calcium-silicates, such as wollastonite.

Examples of preferred combinations of fillers are 20% by weight of glass fibers with 15% by weight of wollastonite and 15% by weight of glass fibers with 15% by weight of wollastonite.

Examples of other additives C) are amounts of up to 30% by weight, preferably from 1 to 40% by weight, in particular from 10 to 15% by weight, of elastomeric polymers (also often termed impact modifiers, elastomers, or rubbers).

These are very generally copolymers preferably composed of at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, 1961), pages 392 to 406 and in the monograph by C. B. Bucknall, “Toughened Plastics” (Applied Science Publishers, London, 1977).

Some preferred types of these elastomers are described below.

Preferred elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentanediene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkylnorbornenes, such as 5-ethylidene-2-norbornene, 5-butylidene-2-norbornene, 2-methallyl-5-norbornene and 2-isopropenyl-5-norbornene, and tricyclodienes, such as 3-methyl-tricyclo(5.2.1.0.^{2.6})-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives and/or comprising epoxy groups are preferably incorporated into the rubber by adding to the monomer mixture monomers comprising dicarboxylic acid groups and/or epoxy groups and having the general formula I, II, III or IV:

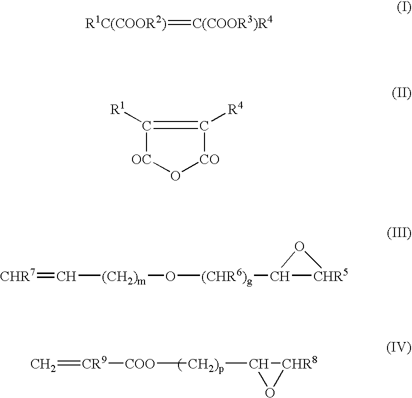

where R¹ to R⁹ are hydrogen or alkyl groups having from 1 to 6 carbon atoms, and m is a whole number from 0 to 20, g is a whole number from 0 to 10 and p is a whole number from 0 to 5.

R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers of

from 50 to 98.9% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid, and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

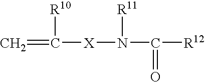

where the substituents may be defined as follows:
R¹⁰ is hydrogen or a C₁-C₄-alkyl group,
R¹¹ is hydrogen or a C₁-C₈-alkyl group or aryl group, in particular phenyl,
R¹² is hydrogen, a C₁-C₁₀-alkyl group, C₆-C₁₂-aryl group or —OR¹³
R¹³ is a C₁-C₈-alkyl group or C₆-C₁₂-aryl group, if appropriate with substitution by O- or N-comprising groups,
X is a chemical bond or C₁-C₁₀-alkylene group or C₆-C₁₂-arylene group-, or

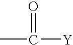

### Y is O-Z or NH-Z, and

Z is a C₁-C₁₀-alkylene group or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, | styrene, acrylonitrile, methyl |
| | n-butyl acrylate, | methacrylate |
| | ethylhexyl acrylate, or | |
| | a mixture of these | |
| II | as I, but with concomitant | as I |
| | use of crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, | first envelope composed of |
| | methyl methacrylate, or | monomers as described under I |
| | a mixture of these | and II for the core, second |
| | | envelope as described under I |
| | | or IV for the envelope |

Instead of graft polymers whose structure has more than one shell, it is also possible to use homogeneous, i.e. single-shell, elastomers composed of 1,3-butadiene, isoprene and n-butyl acrylate or from copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the above-mentioned copolymers, other examples being copolymers of ethylene with comonomers which supply reactive groups.

The elastomers described can also be prepared by other conventional processes, e.g. via suspension polymerization.

Silicone rubbers as described in DE-A 37 25 576, EP-A 235 690, DE-A 38 00 603, and EP-A 319 290 are likewise preferred.

It is, of course, also possible to use mixtures of the rubber types listed above.

The inventive molding compositions can comprise, alongside the essential component A), and also, if appropriate, B) and C), other additives and processing aids D). Their proportion is generally up to 30% by weight, preferably up to 15% by weight, based on the total weight of components (A) to (D).

Examples of conventional additives are stabilizers and oxidation retarders, agents to counteract thermal decomposition and decomposition via ultraviolet light, lubricants and mold-release agents, dyes, pigments, and plasticizers.

The materials generally comprise amounts of up to 4% by weight, preferably from 0.5 to 3.5% by weight, and in particular from 0.5 to 3% by weight of pigments and dyes.

The pigments for pigmenting thermoplastics are well known (see, for example, R. Gächter and H. Müller, Taschenbuch der Kunststoffadditive [Plastics additives handbook], Carl Hanser Verlag, 1983, pp. 494 to 510. A first preferred group of pigments is that of white pigments, such as zinc oxide, zinc sulfide, white lead (2 PbCO3.Pb(OH)2), lithopones, antimony white and titanium dioxide. Of the two most commonly encountered crystalline forms (rutile and anatase) of titanium dioxide it is in particular the rutile form which is used for white coloration of the inventive molding compositions.

Black color pigments which can be used according to the invention are iron oxide black (Fe3O4), spinel black (Cu(Cr,Fe)2O4), manganese black (a mixture composed of manganese dioxide, silicon dioxide, and iron oxide), cobalt black, and antimony black, and also particularly preferably carbon black, mostly used in the form of furnace black or gas black (in which connection see G. Benzing, Pigmente für Anstrichmittel [Pigments for paints], Expert-Verlag (1988), pp. 78 et seq.).

According to the invention, it is also possible, of course, to achieve particular shades by using inorganic chromatic pigments, such as chromium oxide green, or organic chromatic pigments, such as azo pigments or phthalocyanines. Pigments of this type are widely available commercially.

It can also be advantageous to use the pigments or dyes mentioned in a mixture, e.g. carbon black with copper phthalocyanines, because the result is generally easier dispersion of the color in the thermoplastic.

Examples of oxidation retarders and heat stabilizers which may be added to the thermoplastic materials according to the invention are halides of metals of group I of the periodic table of the elements, e.g. sodium halides, potassium halides and lithium halides, if appropriate in combination with cuprous halides, e.g. with chlorides, with bromides, and with iodides. The halides, in particular of copper, can also comprise electron-rich p-ligands. Cu halide complexes with, for example, triphenylphosphine may be mentioned as an example of these copper complexes. It is also possible to use zinc fluoride and zinc chloride. It is also possible to use sterically hindered phenols, hydroquinones, substituted representatives of this group, secondary aromatic amines, if appropriate in combination with phosphorus-comprising acids, or their salts, and mixtures of these compounds, preferably at concentrations of up to 1% by weight, based on the weight of the mixture.

Examples of UV stabilizers are various substituted resorcinols, salicylates, benzotriazoles, and benzophenones, the amounts used generally being up to 2% by weight.

Lubricants and mold-release agents, generally used in amounts of up to 1% by weight of the thermoplastic material, are stearic acid, stearyl alcohol, alkyl stearates, and stearamides, and also esters of pentaerythritol with long-chain fatty acids. It is also possible to use stearates of calcium, of zinc, or of aluminum, or else dialkyl ketone.

Among the additives are also stabilizers which inhibit decomposition of red phosphorus in the presence of moisture and atmospheric oxygen. Examples which may be mentioned are compounds of cadmium, of zinc, of aluminum, of tin, of magnesium, of manganese, and of titanium. Examples of particularly suitable compounds are oxides of the metals mentioned, and also carbonates or oxycarbonates, hydroxides, or else salts of organic or of inorganic acids, e.g. acetates or phosphates, or hydrogenphosphates.

The only flame retardants that will be mentioned here are red phosphorus and the other flame retardants known per se for polyamides.

When components B)-D) are present, the inventive thermoplastic molding compositions can be prepared by processes known per se, by mixing the starting components in conventional mixing apparatuses, such as screw extruders, Brabender mixers, or Banbury mixers, and then extruding them. The extrudate is cooled and comminuted.

The inventive molding compositions feature relatively high heat resistance, good multiaxial impact resistant, and sufficiently high melting points together with high glass transition temperature and a high degree of crystallinity. In particular, they give easy thermoplastic processing and are therefore suitable for production of fibers, of foils, or of moldings. Fiber-reinforced moldings have a very good surface and are therefore particularly suitable for applications in vehicle construction and for electrical and electronics applications.

### EXAMPLES

### General Preparation Specification

×2 g of HMD solution (70% strength in water), ×3 g of metaxylylenediamine, ×4 g of terephthalic acid, ×5 g of isophthalic acid and ×6 g of propionic acid were mixed at 90° C. with ×1 g of water in a plastics container.

The resultant solution was transferred to a 1.5 l autoclave. The operating time of the autoclave was 60 min, with an external temperature of 340° C. and a rotation rate of 40 rpm, and a pressure of 20 bar/abs.

The mixture was then depressurized to a pressure of 2 bar in 60 min.

The resultant PA polymer was pelletized.

The following measurements were made:

Thermal analysis (DSC) was carried out to DIN 53765 (using TAI-Q 1000 equipment) for Tₘ, T_{g}, T_{KK}, and ΔH. The second heating curve was evaluated (20 K/min for heating curve and cooling curve).

VN was measured to ISO 307.

The constitutions of the molding compositions and the results of the measurements are found in the tables.

TABLE 1

| | 6T/6I | X1 | X2 | X3 | X4 | X5 | X6 | | | | | |
|---|---|---|---|---|---|---|---|---|---|---|---|---|
| | MXDA T | Water | HMD | MXDA | T | I | IPrCOOH | Tm | Tg | Tkk | ΔH | |
| Exp | [% by wt.] | g | g | g | g | g | g | ° C. | ° C. | ° C. | J/g | VN |
| 1 | 70/25/5 | 381.06 | 255.1 | 10.14 | 197.71 | 66.20 | 0.9 | 310 | 136 | 255 | 53 | 127 |
| | | | (70.8% | | | | | | | | | |
| | | | in water) | | | | | | | | | |
| 2 | 68/25/7 | 382.52 | 249.93 | 14.19 | 197.36 | 66.2 | 0.9 | 300 | 125 | 257 | 59 | 81 |
| | | | (70.78% | | | | | | | | | |
| | | | in water) | | | | | | | | | |
| 3 | 68/22/10 | 381.45 | 245.45 | 20.27 | 204.78 | 58.25 | 0.9 | 298 | 133 | 246 | 51 | 93 |
| | | | (69.81% | | | | | | | | | |
| | | | in water) | | | | | | | | | |
| 4 | 65/30/5 | 381.06 | 255.1 | 10.14 | 183.47 | 79.44 | 0.9 | 295 | 125 | 250 | 49 | 130 |
| | | | (70.8% | | | | | | | | | |
| | | | in water) | | | | | | | | | |
| 1c | 55/25/20 | 490.69 | 218.91 | 40.53 | 195.10 | 66.20 | 0.9 | 280 | 138 | 215 | 16 | 115 |
| | | | (69.81% | | | | | | | | | |
| | | | in water) | | | | | | | | | |

TABLE 2

| | | 70/25/5 | 68/25/7 | 68/22/10 | 65/30/5 | |
|---|---|---|---|---|---|---|
| | | Inv. ex. 1 | Inv. ex. 2 | Inv. ex. 3 | Inv. ex. 4 | Comp. ex. 1 |
| Hexamethylenediamine | mol % | 47.7 | 47.7 | 45.3 | 47.7 | 40.5 |
| | % by wt. | 39.1 | 39.1 | 37.0 | 39.1 | 32.9 |
| Terephthalic acid | mol % | 37.5 | 36.5 | 38.9 | 35.0 | 37.33 |
| | % by wt. | 43.9 | 42.8 | 45.5 | 41.0 | 43.35 |
| Isophthalic acid | mol % | 12.5 | 13.5 | 11.1 | 15.1 | 12.67 |
| | % by wt. | 14.7 | 15.9 | 12.9 | 17.7 | 14.71 |
| m-Xylylenediamine | mol % | 2.3 | 2.3 | 4.7 | 2.3 | 9.46 |
| | % by wt. | 2.25 | 2.25 | 4.5 | 2.25 | 9.01 |
| ΔH_{crist.} | [J/g] | 53 | 52 | 50 | 49 | 16 |
| VN | [ml/g] | 127 | 81 | 93 | 130 | 115 |
| Tm | | 308 | 303 | 298 | 295 | 280 |
| Tg | | 133 | 129 | 132 | 128 | 138 |
| Tkk | | 255 | 252 | 250 | 248 | 215 |

1. A semiaromatic semicrystalline thermoplastic polyamide molding composition, comprising
A) from 40 to 100% by weight of a copolyamide composed of
a1) from 30 to 44 mol % of units which derive from terephthalic acid
a2) from 6 to 20 mol % of units which derive from isophthalic acid
a3) from 42 to 49.5 mol % of units which derive from hexamethylenediamine
a4) from 0.5 to 8 mol % of units which derive from aromatic diamines having from 6 to 30 carbon atoms,
where the molar percentages of components a1) to a4) together give 100%, and
B) from 0 to 50% by weight of a fibrous or particulate filler
C) from 0 to 30% by weight of an elastomeric polymer
D) from 0 to 30% by weight of other additives and processing aids,
where the percentages by weight of components A) to D) together give 100%.

2. The polyamide molding composition according to claim 1, in which the copolyamide A) comprises
a1) from 32 to 40 mol %
a2) from 10 to 18 mol %
a3) from 45 to 48.5 mol %
a4) from 1.5 to 5 mol %

3. The polyamide molding composition according to claim 1, in which the aromatic diamine a4) comprises
p-xylylenediamine or
m-xylylenediamine or
o-xylylenediamine or
alkyl-substituted xylylenediamines
or a mixture of these.

4. The polyamide molding composition according to claim 1, in which the copolyamide A) has less than 0.5% by weight triamine content.

5. The polyamide molding composition according to claim 1, in which the copolyamide A) has greater than 20% degree of crystallinity.

6. A method for the production of fibers, of foils, or of moldings comprising utilizing the polyamide molding composition according to claim 1 to manufacture fibers, foils or moldings.

7. A molding, obtainable from the polyamide molding compositions according to claim 1.

8. The polyamide molding composition according to claim 2, in which the aromatic diamine a4) comprises
p-xylylenediamine or
m-xylylenediamine or
o-xylylenediamine or
alkyl-substituted xylylenediamines
or a mixture of these.

9. The polyamide molding composition according to claim 2, in which the copolyamide A) has less than 0.5% by weight triamine content.

10. The polyamide molding composition according to claim 3, in which the copolyamide A) has less than 0.5% by weight triamine content.

11. The polyamide molding composition according to claim 2, in which the copolyamide A) has greater than 20% degree of crystallinity.

12. The polyamide molding composition according to claim 3, in which the copolyamide A) has greater than 20% degree of crystallinity.

13. The polyamide molding composition according to claim 4, in which the copolyamide A) has greater than 20% degree of crystallinity.

14. A method for the production of fibers, of foils, or of moldings comprising utilizing the polyamide molding composition according to claim 2 to manufacture fibers, foils or moldings.

15. A method for the production of fibers, of foils, or of moldings comprising utilizing the polyamide molding composition according to claim 3 to manufacture fibers, foils or moldings.

16. A method for the production of fibers, of foils, or of moldings comprising utilizing the polyamide molding composition according to claim 4 to manufacture fibers, foils or moldings.

17. A method for the production of fibers, of foils, or of moldings comprising utilizing the polyamide molding composition according to claim 5 to manufacture fibers, foils or moldings.

18. A molding, obtainable from the polyamide molding compositions according to claim 2.

19. A molding, obtainable from the polyamide molding compositions according to claim 3.

20. A molding, obtainable from the polyamide molding compositions according to claim 4.
